(19) United States
(12) Patent Application Publication
(10) Pub. No.: US 2006/0199574 A1
(43) Pub. Date: Sep. 7, 2006

(54) Method and system for data transfer between interactive public terminals and personal terminals

(75) Inventors: Ramon Cortes, Lattes (FR); Pascal Vandromme, Montpellier (FR); Nicolas Fournil, Montpellier (FR); Sebastien Raison, Montpellier (FR)

Correspondence Address: EGBERT LAW OFFICES, 412 MAIN STREET, 7TH FLOOR, HOUSTON, TX, 77002, US

(73) Assignee: Vanexport Sarl, Castelnau Le Lez (FR)

(21) Appl. No.: 10/541,946

(22) PCT Filed: Jan. 8, 2004
(86) PCT No.: PCT/FR04/50006

§ 371 Date: Mar. 16, 2006

(30) Foreign Application Priority Data
Jan. 8, 2003 (FR) 030201

(51) Int. Cl. H04M 3/00

(52) U.S. Cl. 455/418

(57) ABSTRACT

The method for transferring data, such as sounds and/or images and/or alphanumeric data and/or programs, between at least one electronic terminal and at least one terminal. The method is characterized in that it includes inputting at the electronic terminal used, references of the terminal; selecting, at the terminal, specific data; settling the amount for the selected service, using a payment peripheral installed on the terminal; and transmitting to the terminal, via a communication network, the selected data so as to personalize the terminal. The invention also concerns a data transfer system adapted to implement the method.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention relates to a method and a system for transferring data, such as sounds and/or images and/or alphanumeric data and/or programs, namely chosen among logos, bell tones, games, answering-machine messages or the like, between at least one electronic terminal, such as an interactive public terminal, and at least one terminal, such as electronic devices for personal use, namely a mobile telephone, with a view to personalize it.

### BACKGROUND OF THE INVENTION

Until now, there exist only two solutions for personalizing a mobile telephone with such kind of data:
the first one consisting in entering into communication with a telephone server center such as an <<audiotel >> and in inputting the code of the desired data (for example a bell tone or a logo) and the references of the terminal one wants to personalize: this solution is expensive, on the one hand, because of the high tariff of this kind of connection and, on the other hand, because of the relatively long waiting times for obtaining the requested service, with, in addition, a lack of reliability and a restriction as to the volume of the product catalogue;
the second one consists in entering into communication with an Internet site and in also inputting the code of the desired data and the references of the terminal one wants to personalize; this solution, generally payable by means of a bank card, requires a specific equipment and connection which, unfortunately, are not generalized, with, in addition, the consumer's reticence to electronic payment, even if safe payment.

### BRIEF SUMMARY OF THE INVENTION

Therefore, the invention is aimed at implementing a data-transfer method and system for use by the large public, which copes with the above-mentioned drawbacks.

The invention also relates to a method for transferring data, such as sounds and/or images and/or alphanumeric data and/or programs, between at least one electronic terminal and at least one terminal. This method is characterized in that it consists in:
a) inputting at the level of the electronic terminal used, which is of the type interactive public terminal, the references, namely the telephone address, and, in addition, the brand name and the model, of the terminal to be personalized, which is of the type electronic device for personal use, namely a mobile telephone;
b) selecting, at the level of said terminal, specific data, such as sounds and/or images and/or alphanumeric data and/or programs, namely logos, bell tones, games or answering-machine messages;
c) settling the amount for the selected service, using a payment peripheral installed on said terminal;
d) transmitting to said terminal, via a communication network, the selected data with a view to personalize said terminal.

This invention also relates to a computer program (operating software) including program-code portions for carrying out the steps of this data-transfer method.

The invention also relates to a system for transferring data, such as sounds and/or images and/or alphanumeric data and/or programs, between at least one interactive public terminal and at least one personal terminal to be personalized, namely for implementing the above-mentioned method. This system is characterized in that it includes:
a) at least one terminal, each terminal including:
   a central unit comprising storing means aimed at containing, when the terminal is in service, an operating software as well as data related to offered services;
   means for interaction with a user, such as data-selection and reproduction peripherals;
   means for interaction with an operator, such as an interface for communication with an operating center, via a communication network;
   a mass storage peripheral, containing the operating software and the data which are transferred, at each activation and/or at each switching on of the terminal, to the storage means of the central unit;
b) means for transmitting said selected data to at least one selected personal terminal personnel, this via a telecommunication network;
c) at least one terminal, each terminal including means for reproducing the data received.

The system in question has, for the user, the following additional advantages:
personalization of the mobile telephone in a few seconds, thanks to its ergonomic interface (for example, touch screen);
payment directly on the terminal, by means of coins, bank card, scratch card or any other means of payment;
large capacity of products in catalogue and ease of renewal of its contents;
limited cost, since it is well determined.

It also has, for the operator, the following advantages:
high reliability: the terminal has no mechanical part moving during the operation;
large capacities of evolution: at the level of the software and the modules the terminal is comprised of;
absence of fees to be paid on technology: by using free software;
safety: the sensitive portions of the technology are protected.

The features and advantages of the invention will become clear when reading the following detailed description of at least one preferred embodiment of same given by way of a non-restrictive example and shown in the attached drawings.

### BRIEF DESCRIPTION OF THE SEVERAL VIEWS OF THE DRAWINGS

In these drawings:

FIG. 1 is a schematic view of the installation according to the invention;

FIG. 2 is a schematic view of the data exchange between the main subunits of the terminal according to the invention.

### DETAILED DESCRIPTION OF THE INVENTION

The invention relates to a method for transferring data (D), such as sounds and/or images and/or alphanumerical data and/or programs, between at least one electronic terminal (B1, Bn) and at least one terminal (T1, Tn). According to this invention, this transfer method consists in:
a) inputting, at the level of the electronic terminal (B1) used, which is of the type interactive public terminal, the references (namely the telephone address and, in addition, the brand name and model, even the operator) of the terminal (T1), to be personalized, which is of the type electronic device for personal use, namely a mobile telephone;
b) selecting, at the level of said terminal (B1), specific data (D), such as sounds (for example, bell tones, musical parts, answering-machine messages . . . ) and/or images (for example, logos, images, backgrounds and screen savers . . . ) and/or alphanumerical data and/or programs (for example games or the like);
c) settling the amount for the selected service, by using a payment peripheral installed on said terminal (B1);
d) transmitting to said terminal (T1), via a communication network (R1), the selected data (D), in order to personalize said terminal.

According to another feature of the method according to the invention, before inputting the references of a terminal (T1, Tn), one proceeds to loading, at the level of a volatile memory (MV) and from a mass storage peripheral said electronic terminal (B1, Bn) includes, a software for operating the method as well as data (D) related to the services offered which can be selected, namely a visual and/or sound representation of specific data likely to be selected.

In this respect, it should be noted that such a loading can be ensured prior to a first input of the references of one or several terminals (T1) at the level of one and the same terminal or at each one of these inputs.

However and according to a preferred embodiment, such a loading is ensured at each activation and/or at each switching on of the electronic terminal (B1, Bn).

Another feature of the invention consists in that, after inputting the references of a terminal (T1) and before selecting the specific data (D), one proceeds to an analysis of the possibilities of the terminal (T1), depending on the references input, in order to provide specific data compatible with the possibilities of the terminal (T1) and likely to be selected.

This method also consists in that, before selecting the specific data (D), one proceeds to a visual and/or sound reproduction of the specific data (D) likely to be selected, this at the level of means for visual and/or sound reproduction (PR) said electronic terminal (B1, Bn) includes. This advantageously allows a user to select the data he wants to transfer to his terminal (T1) after he has seen, heard and/or tested them.

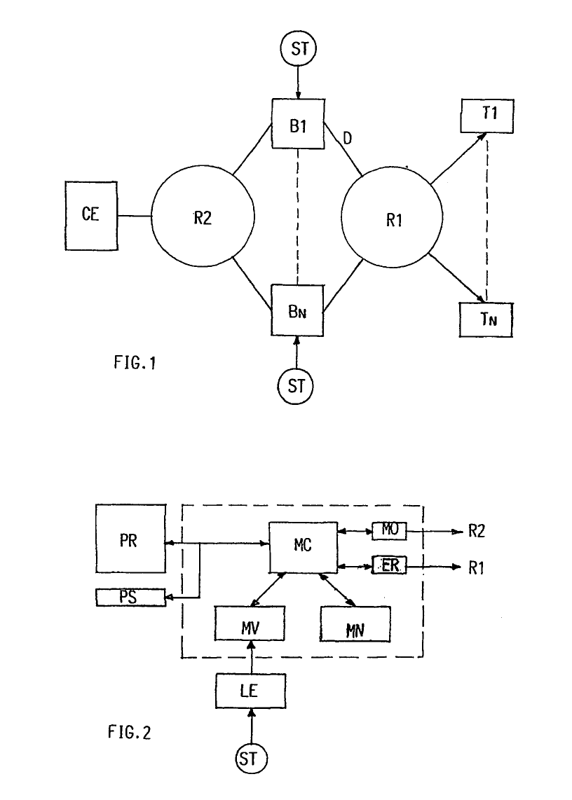

As regards the transfer of the selected data (D) to said terminal (T1, Tn), the latter can be ensured directly from the terminal (B1, Bn) to said terminal (T1, Tn) as can be seen in FIGS. 1 and 2. Such an embodiment implies that the data be present at the level of said terminal (B1, Bn) and that the latter (B1, Bn) includes transmitting means (ER) arranged so as to ensure such a transfer, via a telecommunication network (R1).

However and according to a preferred embodiment of the invention, such a terminal (B1, Bn) does not contain such data, but only a visual and/or sound representation of same. Such a representation may, in no case, be usable directly by a (T1, Tn), thus avoiding any unauthorized use of these data. In fact, the data likely to be transferred to said terminal (T1, Tn) are either present at the level of an operating center (CE), in particular, at the level of a server, or generated from special data (for example, masters) present at the level of such an operating center (CE), namely a server.

The method then consists in that, prior to the transmission of the selected data (D) to the terminal (T1), a designation of the selected data is first transmitted (via a telecommunication network (R2)), from said terminal (B1, Bn) to such an operating center (CE). This operating center (CE) then transmits (via a telecommunication network (R1)), the selected data to said terminal (T1) based on the designation of the selected data received.

In this respect, it should be noted that the designation of the selected data can be completed with information related to the references of the terminal (brand name, model, call number . . . ), to the operator, to the user (namely information regarding a means of payment), even to means for identifying the terminal (B1, Bn) at which the user inputs this information or the like. The transmission of this information towards the operating center (CE) can be ensured in an encoded or encrypted way. This information can be used, namely at the level of the operating center (CE), in order to ensure a follow-up of the quality of the service, to ensure a trackability, to proceed to invoicing (or to a re-invoicing, for example to an operator), to proceed to statistical studies, to prepare an order (namely of an electronic type for the selected data) or the like.

According to another feature, the invention also relates to a computer program including program-code portions for carrying out the steps of this data-transfer method. This computer program is, at least partly, comprised of the above-mentioned application software and is designed capable of automatically controlling this method as well as the interfaces, peripherals and other technical means implemented by this method.

The invention also relates to a system for transferring data (D), such as sounds and/or images and/or alphanumerical data and/or programs, between at least one interactive public terminal (B1, Bn) and at least one personal terminal (T1, Tn) to be personalized. This system can, in particular, be adapted for implementing the above method.

This system is characterized in that it includes
a) at least one terminal (B1, Bn), each terminal (B1, Bn) including:
   a central unit comprising storage means aimed at containing, when the terminal is operating, an operating software as well as data (D) regarding the services offered;
   means for interaction with a user, such as selection (PS) and reproduction peripherals (PR) for the data (D);
   means for interaction with an operator, such as a communication interface (MO), for instance such as a modem, for a communication with an operating center (CE), namely such as a server, via a communication network (R2);
   a mass storage peripheral, containing the operating software and the data (D) which are transferred, at each activation and/or at each switching on of the terminal, to the storage means of the central unit;
b) means for transmitting said selected data (D) to at least one selected personal terminal (T1), this via a telecommunication network (R1);
c) at least one terminal (T1, Tn), for example such as a mobile telephone or portable computer, each terminal (T1, Tn) including means for reproducing the data (D) received.

In fact, each terminal (B1, Bn) includes a central unit comprising a PC-compatible master card, a PC-compatible processor (MC), for example of the type P3 500 MHz, storage means.

Such storage means of each terminal (B1, Bn) are defined, at least partly, by a volatile memory (MV), namely such as a RAM, for example with a 256 Mb capacity.

This volatile memory (MV) is aimed at containing, when the terminal (B1, Bn) is operating, the operating software as well as the data (D) regarding the services offered. To this volatile memory (MV) are transferred the operating software and these data (D), this at each activation and/or at each switching on of the terminal, even before an input of the reference of one or several terminals (T1, Tn).

In fact and as mentioned above, the data regarding the services offered can be recorded at the level of the terminal (B1, Bn) in a form capable of being transferred directly to a terminal (T1, Tn) and used directly by the latter.

To this end, the terminal (B1, Bn) includes means (ER) arranged so as to ensure directly a transmission of the selected data (D) to the personal terminal (T1), via a telecommunication network (R1), as can be seen in FIGS. 1 and 2.

Such transmission means (ER) can be formed, for example, by a transmitter/receiver such as a GSM or the like.

However and according to a preferred embodiment, the data (D) regarding the services offered, contained, as the case may be, at the level of the mass storage peripheral or at the level of the volatile memory (MV), are formed by visual and/or sound representations of the specific data likely to be selected, but in no way by data directly usable by a terminal (such data being, in fact and only, contained or generated at the level of the operating center CE).

This being said, the terminal (B1, Bn) includes means for transmitting (MO) to the operating center (CE) a designation of the selected data, this via a communication network (R2). This operating center (CE) then includes means for transmitting (for example such as a GSM transmitter/receiver) the selected data to said terminal (T1), via a communication network (R1), this based on the designation of these data received.

According to another feature of the system according to the invention, the storage means of each terminal (B1, Bn) are defined, at least partly, by a non-volatile memory (MN) including an encrypting key for the identifiers of the subunits of the terminal and means for loading (ST) the operating software and the data, or for downloading (MO) said information from the operating center (CE), which is re-calculated, at each loading or downloading, and compared with the stored key in order to authorize, or not, its operation.

Such a non-volatile memory (MN) can namely be of the EEPROM type, for example with a 2 Mb capacity.

As regards the peripherals for selecting (PS) and reproducing (PR) the data (D) of each terminal (B1, Bn), they can be formed by means of a touch screen.

Another embodiment consists in that the peripheral for selecting (PS) the data (D) can be a keyboard and the peripheral for reproducing (PR) same can be a display and loudspeakers.

As regards said mass storage peripheral, containing the operating software and the data (D), it can be of the type hard disk and/or DVD/CD drive (LE) associated with a DVD/CD (ST).

In fact and according to a preferred embodiment, such a mass storage peripheral is preferably designed so as to allow a quick replacement and/or updating of the software and or the data. This peripheral is preferably designed, at least partly, removable, and this in an easy way. Thus and according to a preferred embodiment, this peripheral is comprised of a DVD/CD drive associated with an interchangeable DVD/CD.

Each terminal (B1, Bn) includes a peripheral for cash payment (coins, bank-notes . . . ), card (chip cards, magnetic cards or the like) or for a prepaid voucher (number, promotional code, scrap card, publicity coin . . . ) or of any other type.

Each terminal (B1, Bn) can also include:
means adapted to send, at regular time intervals, an operating report to the operating center (CE) as well as a statement on its operation and/or an event log;
means adapted to input and send telemessages;
means adapted to input and send photographs, namely of the type (<<webcam>>.

The communication network (R1) can be of the hertzian type, namely GSM, GPRS, UMTS, of the switched type or of any other type.

The communication network (R2) can be of the hertzian type, namely GSM, GPRS, UMTS, of the switched type or of any other type.

The communication networks (R1) and (R2) can be one and the same.

The terminal can be fully autonomous as regards the electric-current supply (electric batteries or solar panels) and as regards the communication network connection in the event the networks (R1) and (R2) are wireless connections.

The general operation of the software of each terminal is as follows:
at the start, the loading software (loader) tests the validity of the equipment, thanks to the data contained in the non-volatile memory;
when the equipment is validated, the loader transfers the operating software, or application software (applicative) and the data from the mass memory to the volatile memory;
if not, the system is declared corrupted and the loader is stopped;
the loader then passes hands to the application, which then allows an interactive use of the terminal.

The general operation of the application is as follows
it controls the display, the input and the peripherals of the system;
the user generally proceeds to selections among the choices proposed on the screen by designated them, for example, with his finger in the case of using a touch screen;
the payment depends on the requested service; the detection of the coins is performed by the coin device, but the counting is performed by the application;
once the payment has been validated, the data and the controls forming the service are sent directly or indirectly, to the terminal selected via R1 and/or R2.

The software is modular as to its basic configuration and new modules can be added. Of course, the invention is not limited to the embodiments described and shown, for which other variants can be foreseen, in particular as regards:
the type and the number of subunits and peripherals associated with a data terminal;
the type and the number of operating software and of data contained in the storage memories;
the type and the number of personal terminals to be selected;
the type and the number of operating centers within the framework of a centralized or regionalized configuration;
the type and the number of communication networks used;
and to extend it to other applications.

1. Method for transferring data, such as sounds and/or images and/or alphanumeric data and/or programs, between at least one electronic terminal and at least one terminal comprising the steps of:
inputting at a level of an electronic terminal used, which is of the type interactive public terminal, the references, namely the telephone address, and, in addition, the brand name and the model, of the terminal to be personalized, which is of the type electronic device for personal use, namely a mobile telephone;
selecting, at the level of said terminal, specific data, such as sounds and/or images and/or alphanumeric data and/or programs, namely logos, bell tones, games or answering-machine messages;
settling the amount for the selected service, using a payment peripheral installed on said terminal (B1); and
transmitting to said terminal, via a communication network, the selected data with a view to personalize said terminal.

2. Method for transferring data according to claim 1, further comprising, before inputting the references of a terminal:
loading, at the level of a volatile memory and from a mass storage peripheral said electronic terminal having a software for operating as well as data related to the services offered which can be selected, namely a visual and/or sound representation of specific data likely to be selected.

3. Method for transferring data according to claim 1, further comprising, after inputting the references of a terminal and before selecting the specific data analyzing possibilities of the terminal, depending on the references input, in order to provide specific data compatible with the possibilities of the terminal and likely to be selected.

4. Method for transferring data according to claim 1, further comprising, before selecting the specific data, reproducing a visual and/or sound of the specific data likely to be selected, this at the level of means for visual and/or sound reproduction of said electronic terminal.

5. Method for transferring data according to claim 1, further comprising transmitting the selected data directly from the terminal to said terminal, or transmitting a designation of the selected data first from said terminal to an operating center, this operating center then transmitting the selected data to said terminal based on the designation of the selected data received.

6. Computer program of program-code portions for carrying out the steps of the method for transferring data according to claim 1.

7. System for transferring data, such as sounds and/or images and/or alphanumerical data and/or programs, between at least one interactive public terminal and at least one personal terminal to be personalized, namely for implementing the method according to claim 1, said system comprising:
at least one terminal, each terminal being comprised of:
a central unit comprising storage means aimed at containing, when the terminal is operating, an operating software as well as data regarding the services offered;
means for interaction with a user, such as selection and reproduction peripherals for the data;
means for interaction with an operator, such as a interface for communicating with an operating center, via a communication network;
a mass storage peripheral, containing the operating software and the data which are transferred, at each activation and/or at each switching on of the terminal, to the storage means of the central unit;
means for transmitting said selected data to at least one selected personal terminal, this via a telecommunication network; and
at least one terminal, each terminal being comprised of means for reproducing the data received.

8. System according to claim 7, wherein said storage means of each terminal are defined, at least partly, by a volatile memory, on the one hand and when the terminal is operating, which is aimed at containing the operating software as well as the data related to the services offered and, on the other hand, to which this operating software and these data are transferred, this at each activation and/or at each switching on of the terminal.

9. System according to claim 7, wherein the data related to services offered contained, as the case may be, at the level of the mass storage peripheral or at the level of the volatile memory are formed by visual and/or sound representations of the specific data likely to be selected.

10. System according to claim 7, wherein the storage means of each terminal are defined, at least partly, by a non-volatile memory comprised of an encrypting key for the identifiers of the subunits of the terminal and means for loading the operating software and the data, or for downloading said information from the operating center, which is re-calculated, at each loading or downloading, and compared with the stored key in order to authorize, or not, its operation.

11. System according to claim 7, wherein each terminal comprises means adapted to send, at regular time intervals, an operating report to the operating center as well as a statement on its operation and/or an event log.

12. System according to claim 7, wherein the peripherals for selecting and reproducing the data of each terminal are formed by a touch screen.

13. System according to claim 7, wherein the peripherals for selecting and reproducing the data is a keyboard and the peripheral for reproducing same is a display.

14. System according to claim 7, wherein each terminal comprises a peripheral for payment, namely with coins, card, prepaid voucher or by any other payment means.

15. System according to claim 7, wherein each terminal comprises means adapted to input and send telemessages.

16. System according to claim 7, wherein each terminal comprises means adapted to input and send photographs.

17. System according to claim 7, wherein the terminal comprises means arranged so as to directly ensure a transmission of the selected data from the terminal to the personal terminal, via a telecommunication network.

18. System according to claim 7, wherein the terminal comprises means for transmitting to the operating center, via a communication network, wherein a designation of the selected data and in that the operating center comprises means for transmitting, via a communication network, the selected data to said terminal based on the designation of the selected data received.

19. System according to claim 7, wherein the communication network is comprised of the hertzian type, namely GSM, GPRS, UMTS, or of a switched type.

20. System according to claim 7, wherein the communication network is comprised of the hertzian type, namely GSM, GPRS, UMTS, or of a switched type.

21. System according to claim 19, wherein the communication networks are one and the same.
